(19) United States
(12) Patent Application Publication
(10) Pub. No.: US 2012/0135864 A1
(43) Pub. Date: May 31, 2012

(54) POLLINATION IMPROVER

(75) Inventors: Richard Williams, Colchester (GB); Peter Roose, Ghent (BE); Johan Josef De Saegher, Ghent (BE)

(73) Assignee: TAMINCO, NAAMLOZE VENNOOTSCHAP, Ghent (BE)

(21) Appl. No.: 13/263,662

(22) PCT Filed: Apr. 7, 2009
(86) PCT No.: PCT/IB10/00978

§ 371 Date: Jan. 6, 2012

(30) Foreign Application Priority Data
Apr. 7, 2009 (EP) 09447011.9

(51) Int. Cl. A01N 57/16; A01N 43/38; A01N 47/12; A01N 43/40; A01N 39/04; A01P 21/00; A01N 37/24; A01N 37/10

(52) U.S. Cl. 504/127; 504/149; 504/138; 504/144; 504/130; 504/146; 504/143

(57) ABSTRACT

A composition suitable for improving seed quality in a plant comprising:
(i) a compound selected from an auxin, an auxin precursor, an auxin metabolite or a derivative of said auxin, auxin precursor or auxin metabolite;
(ii) acetaminophen or a derivative thereof;
   and further comprising at least one compound selected from (iii) to (v) wherein:
(iii) is a cytokinin,
(iv) is another agrochemically acceptable additive, and
(v) is a thiosulphate.

### FIELD OF THE INVENTION

This invention relates to a method and composition for improving seed quality in seed bearing plants by treating the plants with, particularly but not exclusively, a composition comprising anthranilic acid, acetaminophen and at least one of a cytokinin, a further agrochemically acceptable additive and a thiosulphate.

### BACKGROUND OF THE INVENTION

It will be appreciated that there is a continuing need to provide ways of improving seed quality and/or seed quantity, particularly in grain producing crops. Such methods should be economically advantageous, i.e. the yield and/or quality should increase by an amount that is economically profitable and significant. Ideally the treatment should not produce significantly extra work, i.e. sprayings and should not require new investments in machinery, equipment or space.

The present invention seeks to address these needs.

### SUMMARY OF THE INVENTION

The present invention relates to the novel use of anthranilic acid or its derivatives in combination with acetaminophen or its derivatives and at least one of a cytokinin, a further agrochemically acceptable additive and a thiosulphate for improving crop quality—in other words to improve pollination.

Anthranilic acid is used as an intermediate for production of dyes, pigments and saccharin. It and its esters are also used in preparing perfumes to imitate jasmine and orange, pharmaceuticals (loop diuretics such as furosemide) and UV-absorbers, as well as corrosion inhibitors for metals and mold inhibitors in soya sauce. Its usefulness in improving seed quality is surprising.

Acetaminophen is widely used as an over-the-counter analgesic and antipyretic. It will be appreciated that its efficacy as part of a package for the improvement of seed quality is surprising.

### STATEMENTS OF THE INVENTION

The present invention is directed to the treatment of a plant with an effective amount of an auxin or an effective salt, ester, or amide thereof including analogs of the auxin and effective salts, ester and amides thereof, in combination with acetaminophen and analogs and derivatives thereof and at least one of a cytokinin, and a further agrochemically acceptable additive, and a thiosulphate at or shortly after the time of pollination or anthesis to improve the seed quality of the plant.

By analog we include a compound that has a similar structure, i.e. same or similar active moiety, and similar chemical properties, e.g. with auxins is capable of improving seed quality.

According to one aspect of the present invention there is provided a composition suitable for improving seed quality in a plant comprising:

(i) a compound selected from an auxin, an auxin precursor, an auxin metabolite or a derivative of said auxin, auxin precursor or auxin metabolite;
(ii) acetaminophen or an analog or derivative thereof;
and further optionally but preferably comprising at least one compound selected from
(iii) to (v) wherein:
(iii) is a cytokinin,
(iv) is an agrochemically acceptable additive comprising at least one compound selected from a) glucose, hydrolysed starch, sucrose, fructose, glycerol, glyceraldehydes, erythrose, ribulose, xylulose or arabinose, monosaccharides including aldoses such as D-Ribose, D-Xylose, L-Arabinose, D-Glucose, D-Mannose and D-Galactose; ketoses such as D-Ribulose and D-Fructose; deoxyaldoses such as 2-Deoxy-D-ribose, L-Fuccose; acetylated amino sugars such as N-Acteyl-D-glucosamine and N-Acetyl-D-galactosamine; acidic monosaccharides such as D-Glucuronic acid, L-Iduronic acid and N-Acetylneuraminic acid, Sugar alcohols such as D-Sorbitol and D-Mannitol, disaccharides including maltose, lactose and sucrose, or an ester or glycoside or metabolic equivalent of such a carbohydrate; b) an organic acid of the Krebs tricarboxylic acid cycle or a metabolic precursor thereof; c) a vitamin or coenzyme, or a precursor thereof; d) a purine or pyrimidine nucleoside, nucleotide or metabolic precursor thereof; e) a naturally occurring fat or oil; or f) an amino acid, and
(v) is a thiosulphate.

For ease of reference we will refer to an auxin, an auxin precursor, an auxin metabolite or a derivative of said auxin, auxin precursor or auxin metabolite or derivative of said auxin, auxin precursor or auxin metabolite as an “auxin-related compound”.

In one embodiment the auxin-related compound is based on an indolic ring. In another embodiment the auxin-related compound is based on a phenolic ring.

In one embodiment the derivative is an acid, a conjugate, a salt, an ester, or an amide of the auxin, auxin precursor, or auxin metabolite.

In one embodiment the derivative is in the form of a conjugate, e.g. conjugated to a sugar, an alcohol, an amino acid, a peptide or a protein.

In one embodiment the auxin precursor is chorismate, anthranilic acid, phosphoribosyl anthraniliate, 1-(O-carboxyphenulamino)-1-deoxyribulose-5-phosphate, indole-3-glycerol-phosphate, indole, indole-3-acetic acid, tryptophan, tryptamine, N-hydroxy tryptamine, indole-3-acetaldoxime, 1-aci-nitro-2-indolylethane, indolic glucosinate, indole-3-acetonitrile (IAN), indole-3-acetaldehyde, indole-3-lactic acid, indole-3-pyruvic acid, or indole-3-ethanol.

The auxin-related compound may be a natural, such as is obtainable from seaweed or algae, or synthetic auxin.

In one embodiment the natural auxin is indole-3-acetic acid (IAA), 4-chloro-indole-3-acetic acid (4-Cl-IAA), phenylacetic acid (PAA), indole-3-butyric acid (IBA), indole-3-acetyl-1-O-β-D-glucose (IAAglc).

In one embodiment the conjugate of the natural auxin is IAA-Inositol, IAA-Inositol-arabinose, IAP1, an IAA-peptide, an IAA glycoprotein, an IAA-glucan, IAA-aspartate, IAA-glucose, IAA-1-O-glucose, IAA-myo-Inositol, IAA-4-O-glucose, IAA-6-O-glucose, IAA-Inositol-galactose, an IAA amide conjugate, or an IAA-amino acid conjugate.

In one embodiment the synthetic auxin is 1-naphthaleneacetic acid (NAA), 2,4-dichlorophenoxyacetic acid (2,4-D), 2-methoxy-3,6-dichlorobenzoic acid (dicamba), 4-amino-3,5,6-trichloropicolinic acid (tordon), 2,4,5-trichlorophenoxyacetic acid (2,4,5-T), 2,3,6-trichlorobenzoic acid, 4-chloro-2 methylphenoxyacetic acid (MCPA) or N,N-dimethylethylthiocarbamate.

In one embodiment the auxin metabolite is indole-3-lactic acid or indole-3-ethanol.

In a preferred embodiment the auxin precursor is anthranilic acid (also referred to herein as “AN”) or a derivative thereof. In a more preferred embodiment use is made of AN.

In one embodiment the derivative of AN or its analog is a salt, an ester, or an amide of the acid, or a conjugate of any of the foregoing.

In one embodiment the derivative compound used in the present invention is in the form of a conjugate, e.g. conjugated to a sugar, an alcohol, an amino acid, a peptide or a protein.

In one embodiment the analog of AN is a compound having the structure shown in FIG. 1.

For ease of reference we will refer to all of the above mentioned AN, analogs and derivatives thereof as “AN-related compounds”.

In one embodiment the acetaminophen derivative is a compound as set out in FIG. 3.

In a preferred embodiment use is made of acetaminophen.

We describe a composition comprising components (i) and (ii).

According to one embodiment there is provided a composition comprising components (i), (ii) and (iii).

According to another embodiment there is provided a composition comprising components (i), (ii) and (iv).

According to a further embodiment there is provided a composition comprising components (i), (ii), (iii) and (iv).

According to a further embodiment there is provided a composition comprising components (i), (ii) and (v).

The combinations claimed and described herein may give rise to a synergistic effect in relation to crop/seed quality.

By “agrochemically acceptable additive” we include components that are tolerated by a plant, and ideally which are beneficial to a plant.

Preferably the agrochemically acceptable component comprises at least one compound selected from c) a vitamin or coenzyme, or a precursor thereof; d) a purine or pyrimidine nucleoside, nucleotide or metabolic precursor thereof; or f) an amino acid.

In a preferred embodiment the composition of the present invention further comprises thiosulphate.

In another aspect of the present invention there is provided a composition of the present invention for use to improve seed/crop quality.

We also describe compositions suitable for improving seed yield in a plant comprising

(i) a compound selected from an auxin, an auxin precursor, an auxin metabolite or a derivative of said auxin, auxin precursor or auxin metabolite;
(ii) acetaminophen or an analog or derivative thereof;
and further comprising at least one compound selected from (iii) and (iv) wherein:
(iii) is a cytokinin, and
(iv) is an agrochemically acceptable additive comprising at least one compound selected from a) glucose, hydrolysed starch, sucrose, fructose, glycerol, glyceraldehydes, erythrose, ribulose, xylulose or arabinose, monosaccharides including aldoses such as D-Ribose, D-Xylose, L-Arabinose, D-Glucose, D-Mannose and D-Galactose; ketoses such as D-Ribulose and D-Fructose; deoxyaldoses such as 2-Deoxy-D-ribose, L-Fuccose; acetylated amino sugars such as N-Acteyl-D-glucosamine and N-Acetyl-D-galactosamine; acidic monosaccharides such as D-Glucuronic acid, L-Iduronic acid and N-Acetylneuraminic acid, Sugar alcohols such as D-Sorbitol and D-Mannitol, disaccharides including maltose, lactose and sucrose, or an ester or glycoside or metabolic equivalent of such a carbohydrate; b) an organic acid of the Krebs tricarboxylic acid cycle or a metabolic precursor thereof; c) a vitamin or coenzyme, or a precursor thereof; d) a purine or pyrimidine nucleoside, nucleotide or metabolic precursor thereof; e) a naturally occurring fat or oil; or f) an amino acid.

We also describe compositions comprising (i) a compound selected from an auxin, an auxin precursor, an auxin metabolite or a derivative of said auxin, auxin precursor or auxin metabolite;

(ii) acetaminophen or an analog or derivative thereof;
and further comprising at least one compound selected from (iii) and (iv) wherein:
(iii) is a cytokinin, and
(iv) is an agrochemically acceptable additive comprising at least one compound selected from a) glucose, hydrolysed starch, sucrose, fructose, glycerol, glyceraldehydes, erythrose, ribulose, xylulose or arabinose, monosaccharides including aldoses such as D-Ribose, D-Xylose, L-Arabinose, D-Glucose, D-Mannose and D-Galactose; ketoses such as D-Ribulose and D-Fructose; deoxyaldoses such as 2-Deoxy-D-ribose, L-Fuccose; acetylated amino sugars such as N-Acteyl-D-glucosamine and N-Acetyl-D-galactosamine; acidic monosaccharides such as D-Glucuronic acid, L-Iduronic acid and N-Acetylneuraminic acid, Sugar alcohols such as D-Sorbitol and D-Mannitol, disaccharides including maltose, lactose and sucrose, or an ester or glycoside or metabolic equivalent of such a carbohydrate; b) an organic acid of the Krebs tricarboxylic acid cycle or a metabolic precursor thereof; c) a vitamin or coenzyme, or a precursor thereof; d) a purine or pyrimidine nucleoside, nucleotide or metabolic precursor thereof; e) a naturally occurring fat or oil; or f) an amino acid for use to improve seed yield.

According to another aspect of the present invention there is provided a method for improving seed quality comprising applying the composition of the present invention to a plant, its seeds or its environs.

There is also described a method for improving seed yield comprising applying the compositions of the present invention to a plant, its seeds or its environs.

The plant can be an agricultural or horticultural species. Non-limiting examples of an agricultural crop include barley, wheat, oilseed rape, navy bean or soya.

According to yet another aspect of the present invention there is provided a method of preparing the composition of the present invention comprising admixing components (i) and (ii) with at least one of components (iii) to (v).

As described below in more detail the components used in the present invention can be applied at the same or different times. Thus, we provide a kit containing at least some of the components in separate containers.

### ADVANTAGES

We have found that an auxin-related compound, and more particularly an AN-related compound, and even more particularly AN, when applied with acetaminophen or an analog or derivative thereof and an agrochemically acceptable additive as a combination or in mixture with other agrochemically acceptable compounds is (amongst other benefits in plants) effective in improving seed/crop quality, wherever this is deemed useful.

We have found that the above compositions improve seed/crop quality when added to a range of species.

We have found that the compositions of the present invention can surprisingly provide a boost in growth and/or vigour to plants under conditions of potential or actual plant stress, such as high/low pH, high/low temperatures, high/low salinity, drought or other unfavourable plant growing conditions.

We have found that the compositions of the present invention are effective in improving final seed yield and seed/crop quantity, wherever this is deemed useful.

### BRIEF DESCRIPTION OF THE FIGURES

FIG. 1 shows structures of examples of analogs of anthranilic acid.

FIG. 2 shows structures of examples of naturally occurring auxins and conjugates.

FIG. 3 shows structures of examples of derivatives of acetaminophen.

FIG. 4 shows an overview of the reactions leading from chorismate to IAA and tryptophan.

FIG. 5 shows the structure of some synthetic auxins.

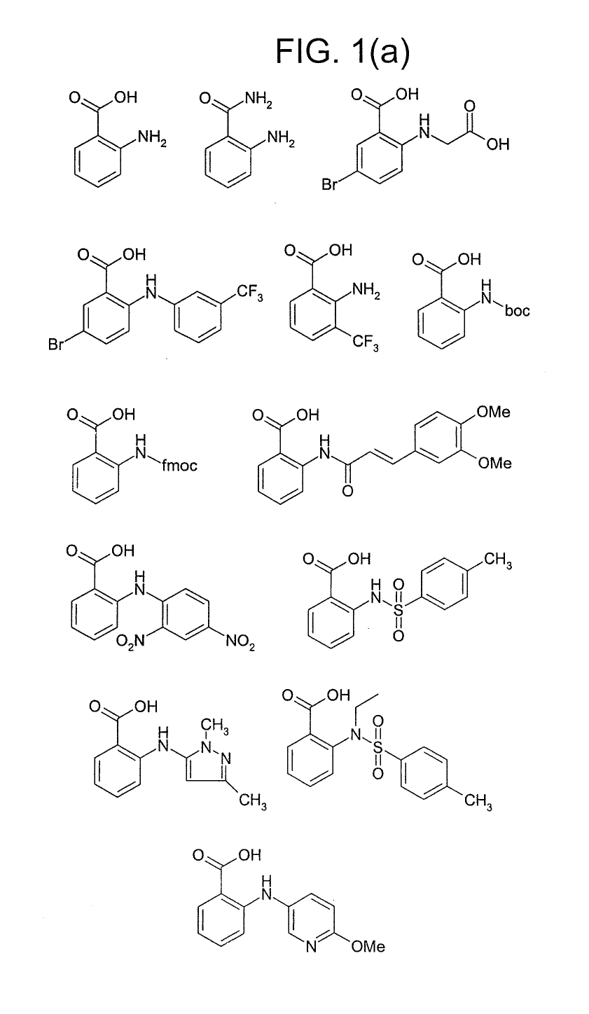

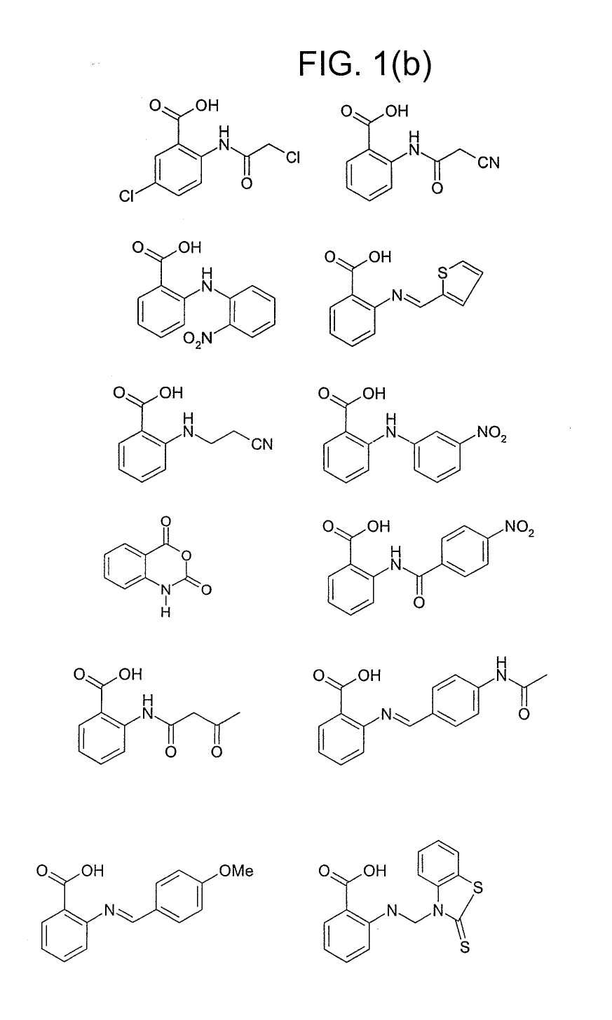

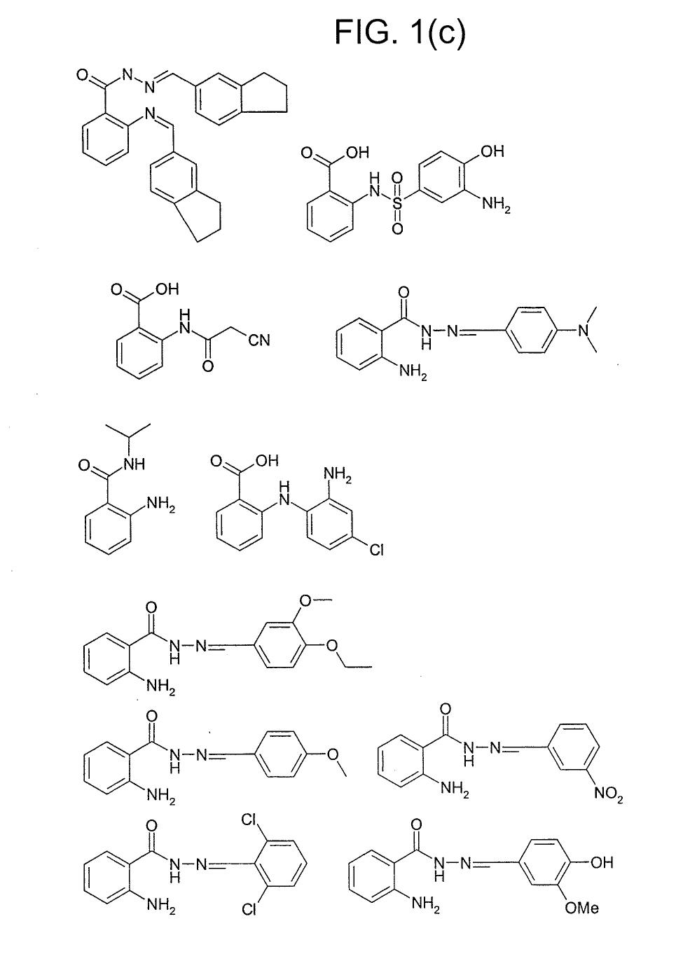

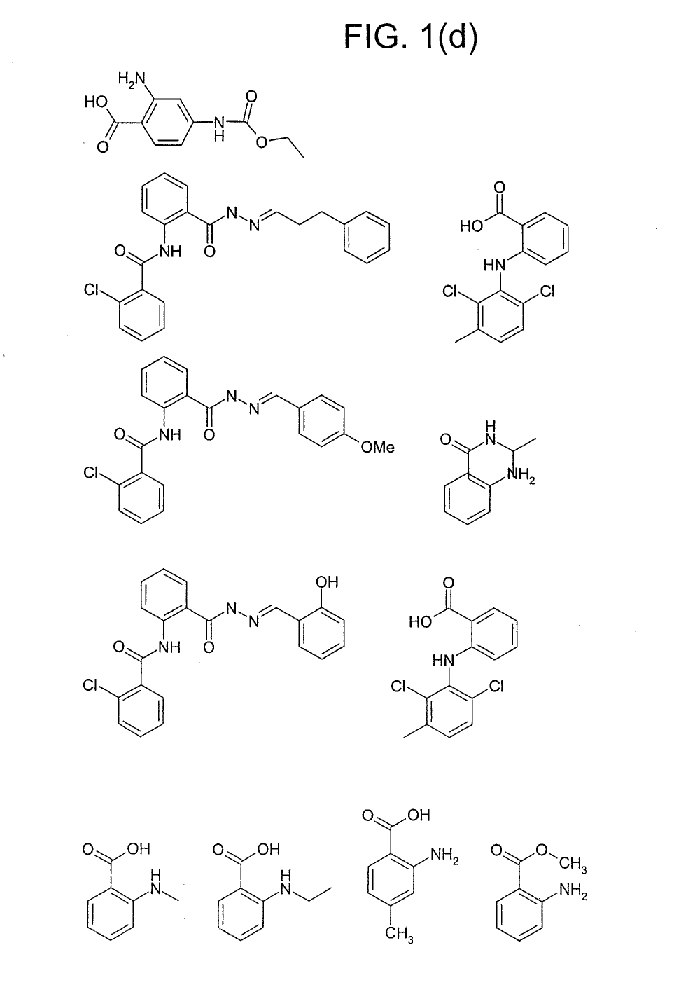

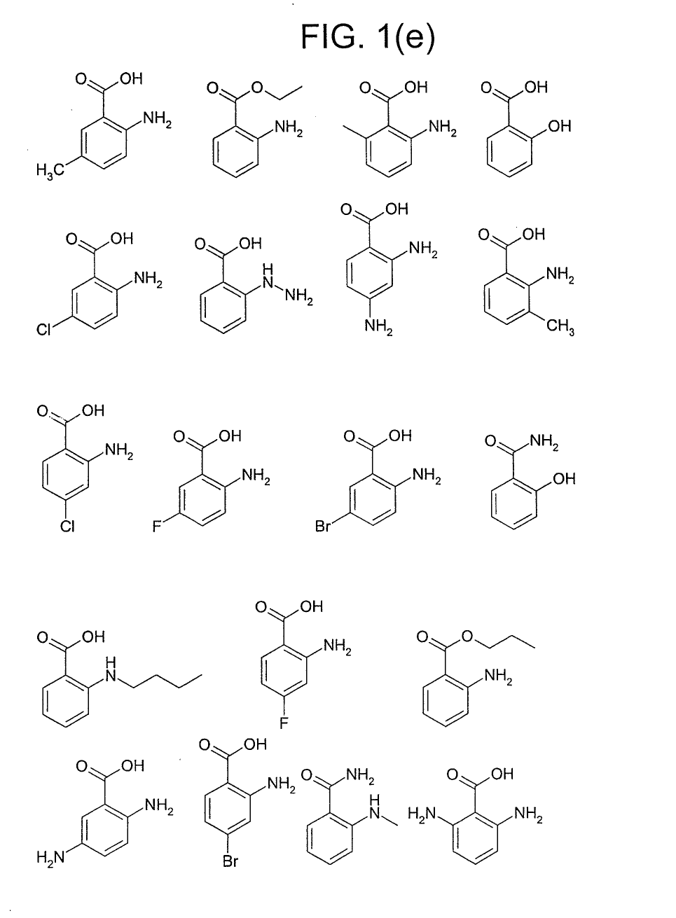

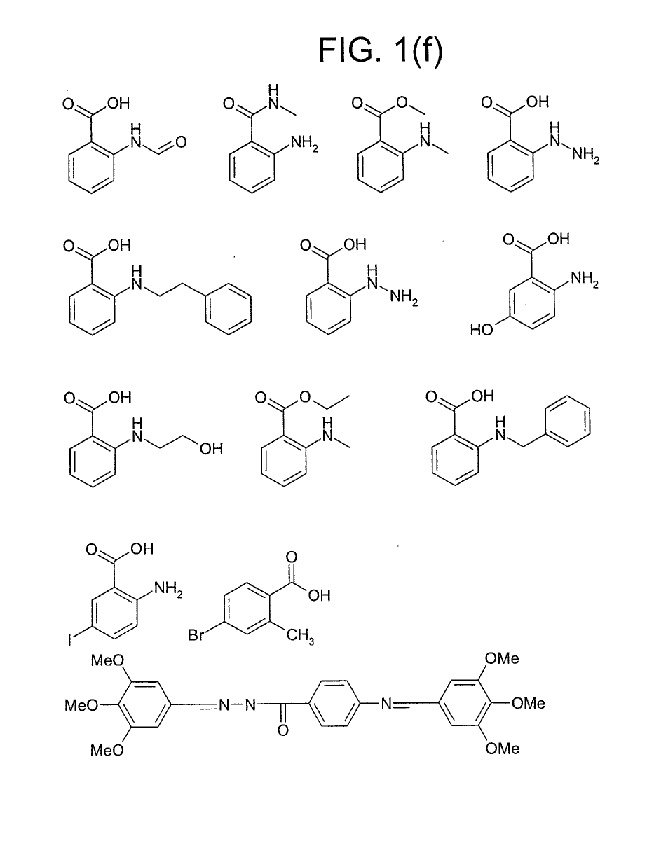

### DETAILED DESCRIPTION OF THE INVENTION

Various preferred features and embodiments of the present invention will now be described by way of non-limiting example.

The invention provides a process and a composition for improving seed/crop quality. The process of the invention includes applying an effective amount of the composition to a plant or its environs.

By “effective amount” we include an amount of the composition of the present invention which is sufficient to achieve the desired “pollination response”. In general by “pollination response” we mean an improvement in at least one of the final seed yield and seed/crop quality compared to a control.

Thousand grain weight, specific weight and % screenings are different aspects of crop quality. For example, specific weight (bushel weight) is the weight of a given volume of grain, expressed in kg/hl. For example, growers have to meet standards of 76 for wheat and 64 for barley in order to meet minimum quality requirements. Varieties with the highest values are those most likely to produce acceptable grain lots. Aspects of crop quality for different varieties of crops are found in The Pocket Guide to Varieties of Cereals, Oilseeds and Pulses (NIAB Association). Other quality standards include, but are not limited to, endosperm texture, protein content (%), Hagberg falling number, Zeleny volume (cc), Chopin Alveograph, malt extract, IBD approval—brewing, IBD approval—distilling, IBD approval—grain distilling, sieving %<2.25 mm, sieving %<2.5 mm, nitrogen content, kernel content, sieving %<2.0 mm, oil content (%), oil type, hilum colour, overseas malting, hot water extract, and seed colour. Examples of % screenings are 2.2 mm and 2.5 mm. Such measures can be used in determining the effect provided by the present invention.

The present invention involves the use of auxins.

Auxins are a class of plant growth hormones. An auxin is an organic substance that promotes cell elongation growth when applied in low concentrations to plant tissue segments in a bioassay. The most studied member of the auxin family is indole-3-acetic acid (IAA). In addition to IAA, there are several other naturally occurring auxins that have been described to date: IAA, IBA, PAA and 4-Cl-IAA. Naturally occurring auxins are found in plants as the free acid and in conjugated forms.

An auxin has been defined as a compound that gives rise to curvature in the grass coleoptile curvature (or growth) test. Such an assay is described by Fritz Went in 1926 and 1928. In this bioassay coleoptile tips of grass seedlings are placed on an agar plate containing the substance to be assayed. If an auxin response is present then the coleoptile bends in darkness and the angle of curvature can be measured. Went's results indicated that the curvatures of stems were proportional to the amount of growth substance in the agar. This test is also called the avena curvature test. Other functional tests which can be employed to determine auxin activity include the ability to cause rooting in stem cuttings and the ability to promote cell division in tissue or cell culture.

A review of auxins, their synthesis and metabolism can be found in e.g. Normanly, Slovin and Cohen in “Plant Hormones, Biosynthesis, Signal Transduction and Action!”, Ed Peter J. Davies, [2004] Chapter “B1. Auxin Biosynthesis and Metabolism” pages 36-62.

In addition to indolic auxins, various phenolic auxins have auxin activity.

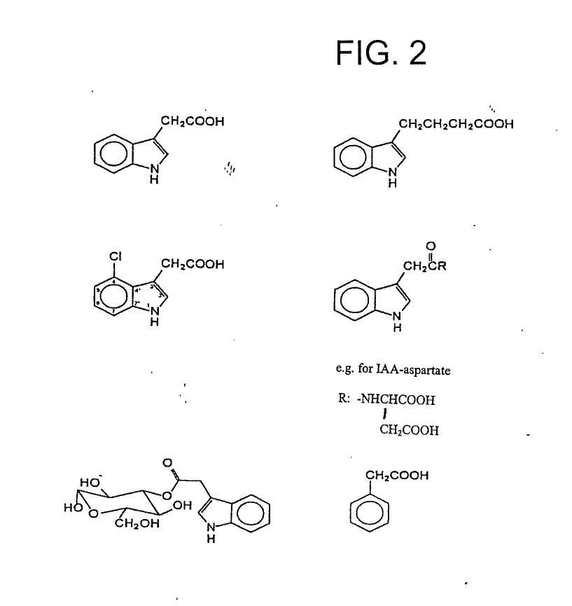

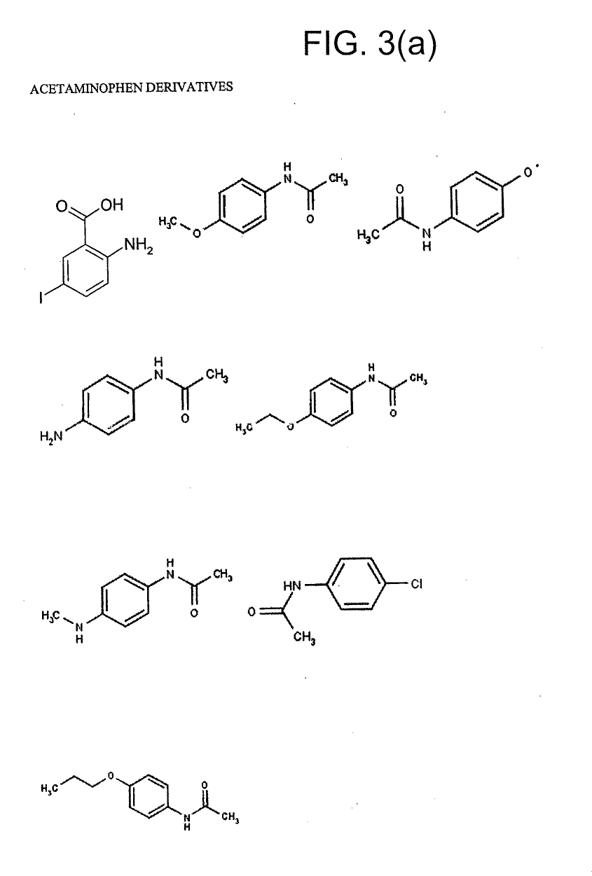

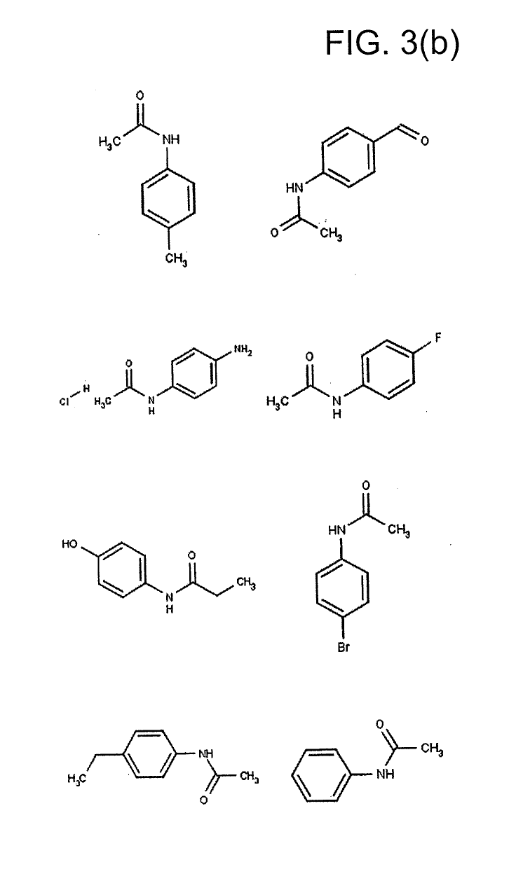

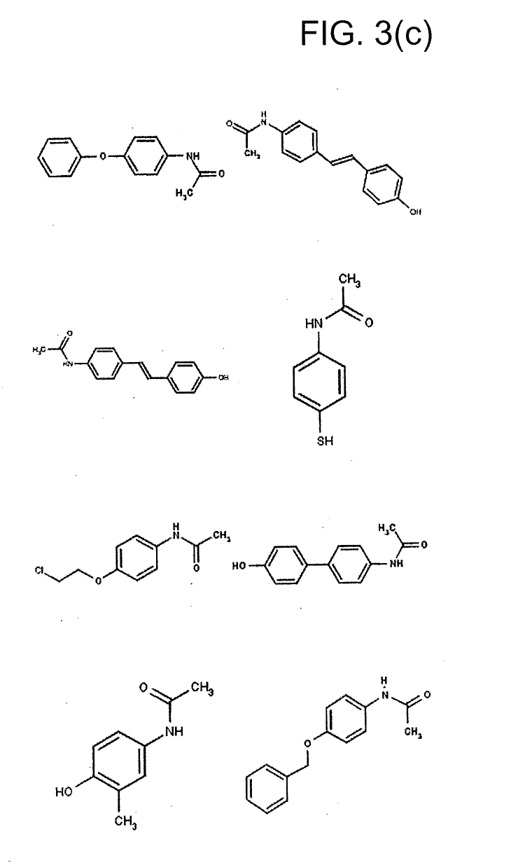

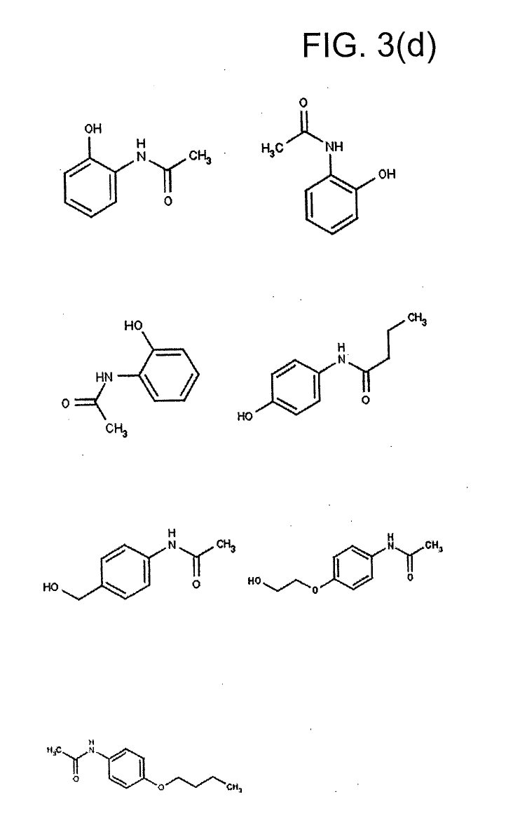

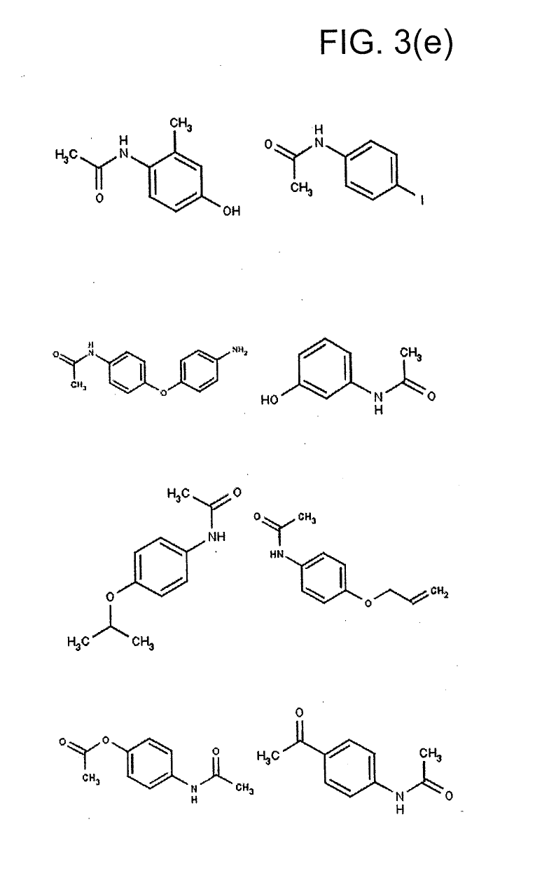

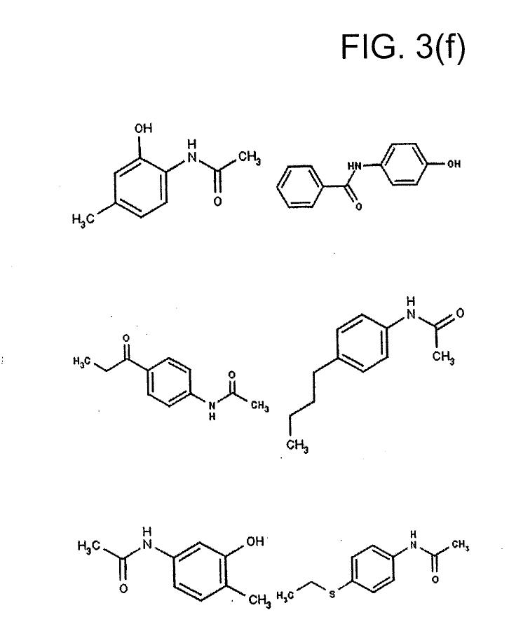

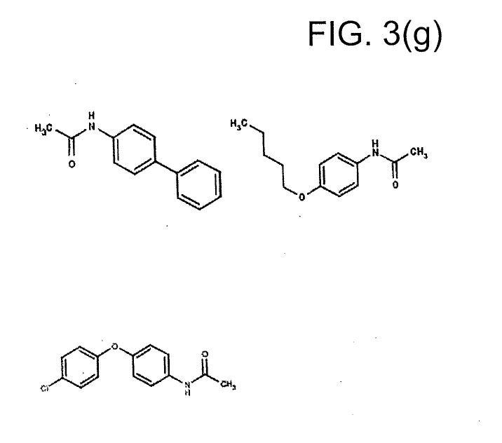

Some examples of naturally occurring auxins and some examples of the lower molecular weight conjugates which may be used in the present invention are shown in FIG. 2.

The present invention may also make use of conjugates. It is believed that plants use conjugates for storage purposes and/or to regulate the amount of free auxin available in the plant. IAA is primarily conjugated to the amino acid aspartate.

Related low molecular weight conjugates, such as IAA-Inos, IAA-Inos-arabinose and conjugates with other amino acids, and higher molecular weight conjugates, such as the IAA protein IAP1, IAA-peptides, IAA glycoprotein and IAA-glucans, have also been isolated from plants.

IAA and its precursors undergo metabolic conversions to indole-3-lactic acid, indole-3-ethanol and IBA. IBA has been found to occur naturally in plants; although some references refer to it as a synthetic auxin. Some commentators refer to it as an auxin per se and others as a precursor to IAA.

One general class of conjugated forms consists of those linked through carbon-oxygen-carbon bridges. These compounds have been referred to generically as “ester-linked”, although some 1-O sugar conjugates such as 1-O-IAA-Gluc are actually linked by acyl alkyl acetal bonds. Typical ester-linked moieties include 6-O-IAGluc, IAA-Inos, IAA-glycoproteins, IAA-glucans and simple methyl and ethyl esters. The other type of conjugates present in plants are linked through carbon-nitrogen-carbon amide bonds (referred to as “amide-linked”), as in the IAA-amino acid and protein and peptide conjugates (see FIG. 2).

Biochemical pathways that result in IAA production within a plant tissue include: (A) de novo synthesis, whether from tryptophan [referred to as Trp-dependent (Trp-D) IAA synthesis], or from indolic precursors of Trp [referred to as Trp-independent (Trp-I) IAA synthesis, since these pathways bypass Trp]; (B) hydrolysis of both amide- and ester-linked IAA conjugates; (C) transport from one site in the plant to another site; and (D) conversion of IBA to IAA. IAA turnover mechanisms include: (E) oxidative catabolism; (F) conjugate synthesis; (G) transport away from a given site; and (H) conversion of IAA to IBA. The present invention makes use of such precursors and metabolites along this pathway. The present invention does not make use of inactive metabolites, such as arise from catabolism of the auxin.

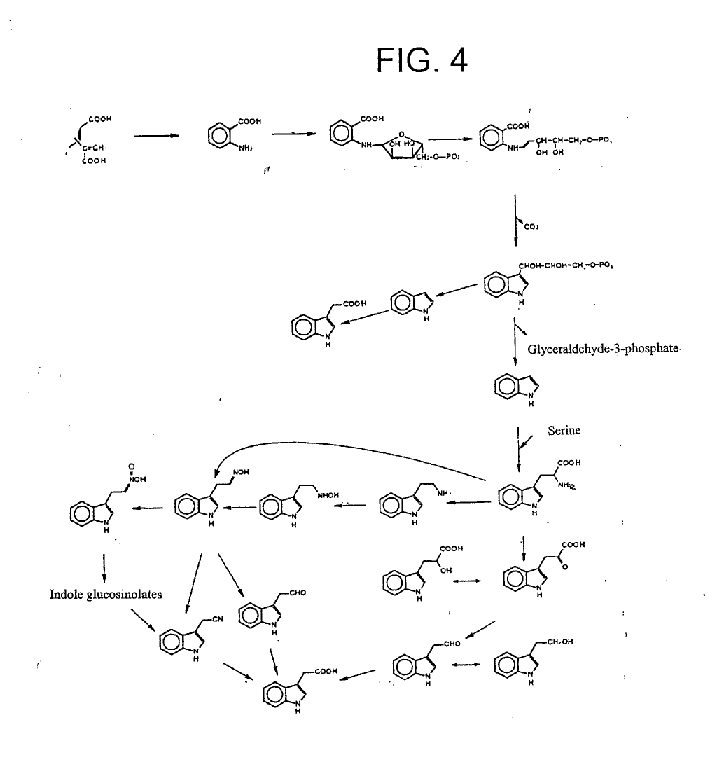

Normally the present invention makes use of the tryptophan-dependent pathway. A summary of the reactions leading from chorismate—the first committed step of indolic metabolism—to IAA and tryptophan is shown in FIG. 4.

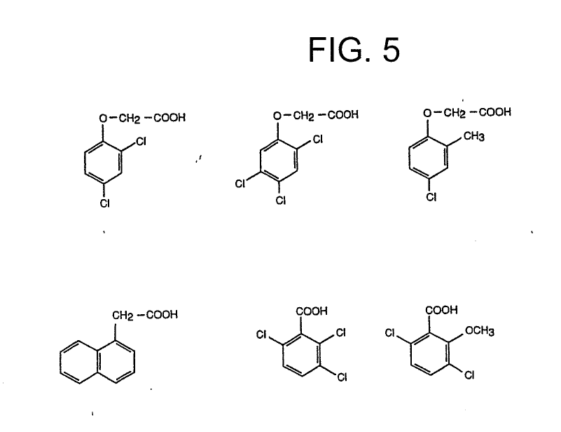

The present invention also encompasses the use of synthetic auxins. Some examples of synthetic auxins are shown in FIG. 5.

A comparison of the compounds that possess auxin activity reveals that at neutral pH they all have a strong negative charge on the carboxyl group of the side chain that is separated from a weaker positive charge on the ring structure by a distance of about 0.5 nm. It has been proposed that an indole is not essential for activity, but that it can be an aromatic or fused aromatic ring of a similar size. A model has been proposed as being a planar aromatic ring-binding platform, a carboxylic acid-binding site and a hydrophobic transition region that separates the two binding sites.

In a preferred embodiment the present invention involves the use of anthranilic acid (AN).

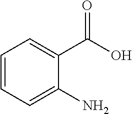

AN, also known as anthraniliate, has the CAS number 118-92-3.

We have described useful derivatives of AN above. Preferably such derivatives are water soluble. Representative salts include inorganic salts such as ammonium, lithium, sodium, potassium, magnesium and calcium salts and organic amine salts such as the triethanolamine, dimethylethanolamine and ethanolamine salts.

The present invention involves the use of acetaminophen.

Acetaminophen has the IUPAC name, N-(4-hydroxypheyl)acetamide and is commonly referred to as paracetamol. It has the CAS number 103-90-2.

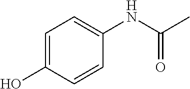

As described above, derivatives of acetaminophen are also useful in the present invention.

The present invention also involves the use of agrochemically acceptable additives.

In one preferred embodiment one such component may be an additive as defined as belonging to one or more of the following classes (a) to (f); although two or more such additives in the same or different classes may be used:
(a) glucose, hydrolysed starch, sucrose, fructose, glycerol, glyceraldehyde, erythrose, xylulose or arabinose, monosaccharides including aldoses such as D-Ribose, D-Xylose, L-Arabinose, D-Glucose, D-Mannose and D-Galactose; ketoses such as D-Ribulose and D-Fructose; deoxyaldoses such as 2-Deoxy-D-ribose, L-Fuccose; acetylated amino sugars such as N-Acteyl-D-glucosamine and N-Acetyl-D-galactosamine; acidic monosaccharides such as D-Glucuronic acid, L-Iduronic acid and N-Acetylneuraminic acid, Sugar alcohols such as D-Sorbitol and D-Mannitol, disaccharides including maltose, lactose and sucrose, or an ester or glycoside or metabolic equivalent of such a carbohydrate, which will normally be applied at 10 to 10,000 g/ha (grams per hectare). Without wishing to be bound by any theory the component may function as
(1) A source for the production of high energy bonds as in adenosine trisephosphate (ATP) production,
(2) For the formation of reduced nicotinamide adenine dinucleotide (NADH) and reduced nicotamide adenine dinucleotide phosphate (NADPH) and
(3) As precursors of amino acids and nucleotides;
(b) an organic acid of the Krebs Tricarboxylic Acid Cycle or a metabolic precursor thereof, (including citric, succinic, malic, pyruvic, acetic and fumaric acids), which will normally be applied at similar rates to and used for similar functions as the carbohydrate source;
(c) a vitamin or coenzyme, e.g. thiamine, riboflavin, pyridozine, pyridoxamine, pyridoxal, nicotinamide, folic acid, or a precursor thereof including nicotinic acid, which will normally be applied at 0.01 to 500 g/ha to stimulate metabolic processes dependent on enzymatic action;
(d) a purine or pyrimidine nucleoside, nucleotide or a metabolic precursor thereof, e.g. adenine, adenosine, thymine, thymidine, cytosine, guanine, guanosine, hypoxanthine, uracil, uridine or inosine, which will normally be applied at 1 to 500 g/ha to act as structural precursors for nucleic acid synthesis;
(e) a naturally occurring fat or oil including olive, soya, coconut and corn oils, which can be degraded by living organisms to fatty acids and which will normally be applied at 10 to 10,000 g/ha;
(f) an amino acid of a type that occurs naturally in plant proteins, e.g. glycine, alanine, valine, leucine, isoleucine, serine, threonine, cysteine, methionine, aspartic acid, glutamic, acid, glutamine, asparagine, lysine, hyroxylysine, arginine, histidine, phenylalanine, tyrosine, tryptophan, proline or hydroxyproline, which will normally be applied at 1 to 500 g/ha to act as structural units for newly formed proteins or by their degradation to function in a similar manner to fatty acids and carbohydrates;

In a preferred embodiment, the composition of the present invention further comprises a cytokinin.

Cytokinins are a class of plant growth substances (plant hormones) that promote cell division. They are primarily involved in cell growth, differentiation, and other physiological processes.

There are two types of cytokinins: adenine-type cytokinins represented by kinetin, zeatin and 6-benzylaminopurine, as well as phenylurea-type cytokinins like diphenylurea or thidiazuron (TDZ). All types of cytokinins can be used in the present invention, including those obtainable from seaweed or algae.

In a preferred embodiment, the composition of the present invention further comprises thiosulphate.

The thiosulphate may be any suitable salt of a metal or other cation. Preferably the thiosulphate is ammonium, sodium or potassium thiosulphate or a mixture thereof. More preferably the thiosulphate is in the form of either ammonium or potassium thiosulphate ((NH₄)₂S₂O₃ or K₂S₂O₃).

The most common form of thiosulphate is ammonium thiosulphate, and this is readily available commercially as a 60% w/w solution, with a pH of about 7.5 and a specific gravity of about 1.32. If a higher proportion of potassium is required in the final foliar fertiliser, the ammonium thiosulphate can be substituted, either partly or wholly, with potassium thiosulphate.

The compositions of the present invention can be used in combination with other components, as appropriate.

Other ingredients such as adjuvants may be added to the solution comprising the composition of the present invention. The adjuvants can facilitate spreading and efficacy, and improve the adhesion properties of the composition, and generally include oils, antifoaming agents and surfactants. Such components which are useful in the present invention include, but are not limited to: terpene, Brij family (polyoxyethylene fatty alcohol ether) from Uniqema (Castle, Del.); surfactant in Tween family (Polyoxyethylene sorbitan esters) from Uniqema (Castle, Del.); Silwet family (Organosilicone) from Union Carbide (Lisle, Ill.); Triton family (Octylphenol ethoxylate) from The Dow Chemical Company (Midland, Mich.); Tomadol family (ethoxylated linear alcohol) from Tomah3 Products, Inc. (Milton, Wis.); Myrj family (Polyoxyethylene (POE) fatty acid esters) from Uniqema (Castle, Del.); Span family (Sorbitan ester) from Uniqema (Castle, Del.); and Trylox family (Ethoxylated Sorbitol and Ethoxylated Sorbitol Esters) from Cognis Corporation (Cincinnati, Ohio) as well as commercial surfactant Latron B-1956 (77.0% modified phthalic/glycerol alkyl resin and 23.0% Butyl alcohol) from Rohm & Haas (Philadelphia, Pa.); Caspil (Blend of Polyether-polymethylsiloxanecopolymer and nonionic surfactant) from Aquatrols (Paulsboro, N.J.); Agral 90 (Nonyl phenol ethoxylate) from Norac Concept, Inc. (Orleans, Ontario, Canada); Kinetic (99.00% Proprietary blend of polyalkyleneoxide modified polydimethylsiloxane and nonionic surfactants) from Setre Chemical Company (Memphis, Tenn.); and Regulaid (90.6% 2-butoxyethanol, poloxalene, monopropylene glycol) from KALO, Inc. (Overland Park, Kans.).

When the final solution is to be applied to plants which, because of their hairy or waxy surface, may be difficult to wet, it may be particularly advantageous to include such other additives, commonly known in the agrochemical industry, such as surfactants, wetting agents, spreaders and stickers. (Examples of wetting agents include silicone surfactants, nonionic surfactants such as alkyl ethoxylates, anionic surfactants such as phosphate ester salts and amphoteric or cationic surfactants such as fatty acid amido alkyl betaines).

The compounds forming the composition of the invention may be the sole active ingredients or they may be admixed with one or more additional active ingredients such as nematicides, insecticides, synergists, herbicides, fungicides, fertilisers or plant growth regulators where appropriate.

In a particularly preferred embodiment, the one or more compounds of the invention are administered in combination optionally with one or more active agents. In such cases, the compounds of the invention may be administered consecutively, simultaneously or sequentially with each other or the one or more active agents. The major advantages of combining the compounds are that it may promote additive or possible synergistic effects through e.g. biochemical interactions. Beneficial combinations may be suggested by studying the activity of the test compounds. This procedure can also be used to determine the order of administration of the agents, i.e. before, simultaneously or after delivery.

Advantageously the compositions of the present invention can be applied at or around the pollination stage. Not only may this give the present results but the composition may also be usefully applied with other treatments used at this stage.

In order to apply the composition of the invention to the plant or environs of the plant, the composition may be used as a concentrate or more usually is formulated into a composition which includes an effective amount of the composition of the present invention together with a suitable inert diluent, carrier material and/or surface active agent. Preferably the composition is in the form of an aqueous solution which may be prepared from the concentrate. By effective amount we mean that the composition (and/or its individual components) provides an improvement in final seed yield and crop quality.

For crop spraying applications, the composition of the present invention is applied in a formulation that is preferably a substantially aqueous solution. The solution comprising the composition of the invention can be mixed on site in the spray tank or delivered and stored in aqueous solution, to ensure proper mixing and dilution, as appropriate.

The applied concentration of the composition of the present invention can vary widely depending on the water volume applied to plants as well as other factors such as plant age and size, and plant sensitivity to the final seed yield and crop quality improver. Typical rates of auxin-related compounds would be 1-10 g/ha (preferably and in these trials, 1 g per hectare was applied), typical rates of acetaminophen or its derivatives would be 1-10 g/ha (preferably and in these trials, 3 g per hectare was applied), and typical rates of the agrochemically acceptable additive of the present invention would be 1-10 g/ha (preferably and in these trials, less than 3 g per hectare was applied. The rate of other components such as spreaders and stickers can be 50-200 ml per ha. The rate of cytokinin can typically be 0.001 to 1.0 percent of the formulation. Typically rates of application of the thiosulphate are 250 g per hectare to 6 kg per hectare.

The rate and timing of application will depend on a number of factors known to those skilled in the art, such as the type of species etc. A second or further application(s) can be made as appropriate. The timings between each application may be in the region of 5 days or more.

The present invention relates to a method of improving crop quality which comprises applying to the plants or to the locus thereof an effective controlling amount of the compound/compositions of the present invention.

The compositions of the present invention can be applied to the soil, plant, seed, or other area to be protected. Preferably the present invention is applied to the foliage of plants. The composition may be applied in the form of dusting powders, wettable powders, granules (slow or fast release), water dispersible granules, emulsion or suspension concentrates, liquid solutions, emulsions, seed dressings, or controlled release formulations such as microencapsulated granules or suspensions, soil drench, irrigation component, or preferably a foliar spray.

Dusting powders are formulated by mixing the active ingredient with one or more finely divided solid carriers and/or diluents, for example natural clays, kaolin, pyrophyllite, bentonite, alumina, montmorillonite, kieselguhr, chalk, diatomaceous earths, calcium phosphates, calcium and magnesium carbonates, sulfur, lime, flours, talc and other organic and inorganic solid carriers.

Granules are formed either by absorbing the active ingredient in a porous granular material for example pumice, attapulgite clays, fuller's earth, kieselguhr, diatomaceous earths, ground corn cobs, and the like, or on to hard core materials such as sands, silicates, mineral carbonates, sulfates, phosphates, or the like. Agents which are commonly used to aid in impregnation, binding or coating the solid carriers include aliphatic and aromatic petroleum solvents, alcohols, polyvinyl acetates, polyvinyl alcohols, ethers, ketones, esters, dextrins, sugars and vegetable oils, with the active ingredient. Other additives may also be included, such as emulsifying agents, wetting agents or dispersing agents.

Microencapsulated formulations (microcapsule suspensions CS) or other controlled release formulations may also be used, particularly for slow release over a period of time, and for seed treatment.

Alternatively and preferred the compositions may be in the form of liquid preparations to be used as dips, irrigation additives or sprays, which are generally aqueous dispersions or emulsions of the active ingredient in the presence of one or more known wetting agents, dispersing agents or emulsifying agents (surface active agents). The compositions which are to be used in the form of aqueous dispersions or emulsions are generally supplied in the form of an emulsifiable concentrate (EC) or a suspension concentrate (SC) containing a high proportion of the active ingredient or ingredients. An EC is an homogeneous liquid composition, usually containing the active ingredient dissolved in a substantially non-volatile organic solvent. An SC is a fine particle size dispersion of solid active ingredient in water. To apply the concentrates they are diluted in water and are usually applied by means of a spray to the area to be treated.

Suitable liquid solvents for ECs include methyl ketone, methyl isobutyl ketone, cyclohexanone, xylenes, toluene, chlorobenzene, paraffins, kerosene, white oil, alcohols (for example, butanol), methylnaphthalene, trimethylbenzene, trichloroethylene, N-methyl-2-pyrrolidone and tetrahydrofurfuryl alcohol (THFA).

These concentrates are often required to withstand storage for prolonged periods and after such storage, to be capable of dilution with water to form aqueous preparations which remain homogeneous for a sufficient time to enable them to be applied by conventional spray equipment. The concentrates may contain 1-85% by weight of the active ingredient or ingredients. When diluted to form aqueous preparations such preparations may contain varying amounts of the active ingredient depending upon the purpose for which they are to be used.

The composition may also be formulated as powders (dry seed treatment DS or water dispersible powder WS) or liquids (flowable concentrate FS, liquid seed treatment LS), or microcapsule suspensions CS for use in seed treatments. The formulations can be applied to the seed by standard techniques and through conventional seed treaters. In use the compositions are applied to the plants, to the locus of the plants, by any of the known means of applying fertiliser compositions, for example, by dusting, spraying, or incorporation of granules.

As indicated above, the fertilisers produced according to this present invention are usually applied to the foliage of plants but may also be applied to the soil or added to the irrigation water.

It will be appreciated that the present invention may be applicable to all horticultural and agricultural species.

The present invention is particularly useful in relation to crops. The crops can include cereals.

Cereals, or cereal grains, are mostly grasses (Poaceae or Gramineae) cultivated for their edible brans or fruit seeds (botanically, a type of fruit called a caryopsis). Cereal grains are grown in greater quantities and provide more energy worldwide than any other type of crop; they are therefore staple crops. They are also a rich source of carbohydrates. In some developing nations, grain in the form of rice, wheat, or maize constitutes a majority of daily sustenance. In developed nations, cereal consumption is more moderate and varied but still substantial. Thus it will be appreciated that the present invention which seeks to improve grain yield and/or quality can provide a substantial economic benefit.

Cereal grains are members of the monocot family Poaceae. Examples of cereals to which the composition of the present invention may usefully be applied include maize, rice, wheat, barley, sorghum, millets, oats, rye, triticale, buckwheat, fonion, quinoa, teff, and wild rice. The present invention is also applicable to winter varieties of such cereals.

The present invention is also applicable to oilseed crops including oilseed rape and grasses such as miscanthus and canary grass.

The present invention can also be usefully applied to bean crops. The term “bean” originally referred to the seed of the broad bean, but was later expanded to include members of the genus Phaseolus, such as the common bean (or navy bean) and the runner bean, and the related genus Vigna. The term is now applied in a general way to many other related plants such as soybeans, peas, lentils, kidney beans, chickpeas (garbanzos), vetches and lupins.

“Bean” can be used as a near-synonym of “pulse”, an edible legume, though the term “pulses” is usually reserved for leguminous crops harvested for their dry grain and usually excludes crops mainly used for oil extraction (like soybeans and peanuts) or those used exclusively for sowing purposes (such as clover and alfalfa). Leguminous crops harvested green for food, such as snap peas, snow peas, etc., are classified as vegetable crops.

In English usage, the word “beans” is also sometimes used to mean the seeds or pods of plants that are not in the family Leguminosae, but which bear a superficial resemblance to true beans, for example coffee beans, castor beans and cocoa beans (which resemble bean seeds), and vanilla beans (which resemble the pods).

The following mixtures of the compound or composition of the present invention are particularly mentioned:

1. The addition of Anthranilic acid (AN), acetaminophen (AC) and an additive (iv) (ADD).
2. The addition of Anthranilic acid (AN), acetaminophen (AC), an additive (iv) (ADD) and thiosulphate.
3. The addition of Anthranilic acid (AN), acetaminophen (AC) and a cytokinin.
4. The addition of Anthranilic acid (AN), acetaminophen (AC), a cytokinin and thiosulphate.
5. The addition of Anthranilic acid (AN), acetaminophen (AC), an additive (iv) (ADD), a cytokinin and thiosulphate.

These and other combinations in accordance with the present invention may give rise to an additive or synergistic effect.

The additive may be one set out as classes (a) to (f) above.

When the additive is selected from class (a) it is preferably one or more of glucose, sucrose, fructose or glycerol.

When the additive is selected from class (b) it is preferably one or more of citric or succinic acid.

When the additive is selected from class (c) it is preferably one or more of thiamine, riboflavin, pyridoxine, nicotinamide, folic acid, ascorbic acid, biotin or vitamin B12.

When the additive is selected from class (d) it is preferably adenine, thymidine, cytosine or uracil.

When the additive is selected from class (e) it is preferably a corn oil.

When the additive is selected from an amino acid is it preferably one of more of glycine, alanine, valine, leucine, threonine, cysteine, methionine, glutamine, asparagine or lysine.

The following Examples further illustrate, but do not limit, the invention.

### EXPERIMENTAL RESULTS

The TAMPF formulation example in these experiments included AN+AC+ADD, applied at the rate of 1 litre per hectare. ADD=at least one from class (f) each at <3 g/l, plus at least one from class (c).

### Thousand Grain Weight

### Trials Information:

Winter Barley: cv Carat, sown 8 May 2008 in standard multi-purpose compost of pH 6.5, at 5/6 seeds per 9 cm pot. Sprayed: 12 June (T1); 19 June (T2). Harvested: 28 July.
Winter Wheat: cv Limerick, sown 8 May 2008 in standard multi-purpose compost of pH 6.5, at 6/7 seeds per 9 cm pot. Sprayed: 15 June (T1); 25 June (T2). Harvested: 28 July.
Navy Bean: cv Primel, sown 5 May 2008 in standard multi-purpose compost of pH 6.5, at 1 seed per 9 cm pot. Sprayed: 22 June (T1); 18 July (T2). Harvested: 28 August.
Soya: sown 5 May 2008 in standard multi-purpose compost of pH 6.5, at 1 seed per 9 cm pot. Sprayed: 24 June (T1); 16 July (T2). Harvested: 28 August.
Statistical Layout: Randomised Complete Block trial, under glasshouse conditions, United Kingdom.

### Statistical Analyses (Least Significant Difference, 5% Level) for Table 1:

TABLE 1

| LSD (5%) | Yield | Yield | Yield | Yield | TGW | TGW |
|---|---|---|---|---|---|---|
| Treatment Means | T1 | T1 | T2 | T2 | T1 | T2 |
| | 1.54 | | 1.49 | | 1.20 | 1.16 |

TABLE 2

| LSD (5%) | Yield | Yield | Yield | Yield | TGW | TGW |
|---|---|---|---|---|---|---|
| Treatment Means | T1 | T1 | T2 | T2 | T1 | T2 |
| | 1.63 | | 1.67 | | 1.09 | 1.08 |

TABLE 3

| LSD (5%) | Yield | Yield | Yield | Yield | TGW | TGW |
|---|---|---|---|---|---|---|
| Treatment Means | T1 | T1 | T2 | T2 | T1 | T2 |
| | 2.88 | | 2.79 | | 2.08 | 2.05 |

TABLE 4

| LSD (5%) | Yield | Yield | Yield | Yield | TGW | TGW |
|---|---|---|---|---|---|---|
| Treatment Means | T1 | T1 | T2 | T2 | T1 | T2 |
| | 1.88 | | 1.70 | | 1.30 | 1.34 |

TABLE 1
WINTER BARLEY - GRAIN YIELD AND THOUSAND GRAIN WEIGHT BENEFITS
FROM THE FOLLOWING APPLICATION TIMINGS: T1 (Growth Stage 52: one
quarter ear emergence) or T2 (Growth Stage 65-69: one week after full ear emergence,
ie at time of anthesis).

| | | | | | | Thousand | Thousand |
|---|---|---|---|---|---|---|---|
| | | Grain | Grain | Grain | Grain | Grain | Grain |
| | | Yield | Yield | Yield | Yield | Weight | Weight |
| | | (g per | (%) | (g per | (%) | (g) | (g) |
| | | Pot) T1 | T1 | Pot) T2 | T2 | T1 | T2 |
| Treatment | | Timing | Timing | Timing | Timing | Timing | Timing |
| 1. | Untreated | 24.8 | 100.0 | 24.8 | 100.0 | 44.2 | 44.6 |
| 2. | Untreated | 24.8 | 100.0 | 24.8 | 100.0 | 43.9 | 44.0 |
| 3. | AN | 24.0 | 96.8 | 24.5 | 98.8 | | |
| 4. | AC | 25.5 | 102.8 | 24.5 | 98.8 | | |
| 5. | AN + AC | 25.3 | 102.0 | 24.0 | 96.8 | 44.0 | 44.2 |
| 6. | AN + AC + | 24.9 | 100.4 | 24.5 | 98.8 | | |
| | Terpene | | | | | | |
| 7. | ADD | 24.5 | 98.8 | 24.7 | 99.6 | | |
| 8. | AN + ADD | 24.7 | 99.6 | 24.7 | 99.6 | | |
| 9. | AC + ADD | 24.8 | 100.0 | 24.9 | 100.4 | | |
| 10. | AN + AC + ADD | 25.7 | 103.6 | 25.8 | 104.0 | 45.8 | 45.6 |
| 11. | AN + AC + | 25.9 | 104.4 | 25.9 | 104.4 | 46.0 | 45.9 |
| | ADD + Terpene | | | | | | |
| 12. | Thiosulphate | 25.5 | 102.8 | 25.4 | 102.4 | 46.5 | 46.4 |
| 13. | Thiosulphate + | 26.0 | 104.8 | 26.0 | 104.8 | 46.5 | 46.8 |
| | AN + AC | | | | | | |
| 14. | Thiosulphate + | 27.3 | 110.1 | 27.4 | 110.5 | 47.0 | 47.1 |
| | AN + AC + ADD | | | | | | |
| 15. | Thiosulphate + | 27.4 | 110.5 | 27.3 | 110.0 | 47.4 | 47.5 |
| | AN + AC + | | | | | | |
| | ADD + Terpene | | | | | | |
| 16. | Cytokinin | 25.3 | 102.0 | 25.2 | 101.6 | 46.1 | 46.3 |
| 17. | Cytokinin + AN | 25.0 | 100.8 | 25.3 | 102.0 | | |
| 18. | Cytokinin + AC | 25.3 | 102.0 | 25.0 | 100.8 | | |
| 19. | Cytokinin + | 26.1 | 104.4 | 26.2 | 105.6 | 46.8 | 47.1 |
| | AN + AC | | | | | | |
| 20. | Cytokinin + | 26.7 | 107.7 | 26.5 | 106.9 | 47.8 | 47.9 |
| | AN + AC + ADD | | | | | | |
| 21. | Cytokinin + | 26.8 | 108.1 | 26.6 | 107.3 | 47.8 | 47.7 |
| | AN + AC + | | | | | | |
| | ADD + Terpene | | | | | | |
| 22. | Cytokinin + | 25.6 | 103.2 | 25.5 | 102.8 | | |
| | ADD | | | | | | |
| 23. | Cytokinin + | 25.5 | 102.8 | 25.8 | 104.0 | | |
| | ADD + Terpene | | | | | | |
| 24. | Cytokinin + | 25.2 | 101.6 | 25.1 | 101.2 | | |
| | Terpene | | | | | | |
| 25. | Cytokinin + | 25.8 | 104.0 | 25.3 | 102.0 | | |
| | Thiosulphate | | | | | | |
| 26. | Cytokinin + | 25.8 | 104.0 | 25.0 | 100.8 | | |
| | Thiosulphate + ADD | | | | | | |
| 27. | Cytokinin + | 26.3 | 106.0 | 26.2 | 105.6 | | |
| | Thiosulphate + | | | | | | |
| | AN + AC | | | | | | |
| 28. | Cytokinin + | 27.2 | 109.7 | 27.0 | 108.9 | 48.0 | 47.8 |
| | Thiosulphate + | | | | | | |
| | AN + AC + ADD | | | | | | |
| 29. | Cytokinin + | 25.6 | 103.2 | 25.4 | 102.4 | | |
| | Thiosulphate + | | | | | | |
| | Terpene | | | | | | |
| 30. | Cytokinin + | 27.5 | 110.9 | 27.5 | 110.9 | 47.9 | 47.7 |
| | Thiosulphate + | | | | | | |
| | AN + AC + | | | | | | |
| | ADD + Terpene | | | | | | |
| 31. | Terpene + ADD | 25.7 | 103.6 | 25.3 | 102.0 | | |
| 32. | Terpene | 25.8 | 104.0 | 25.2 | 101.6 | | |

TABLE 2
WINTER WHEAT - GRAIN YIELD AND THOUSAND GRAIN WEIGHT BENEFITS
FROM THE FOLLOWING APPLICATION TIMINGS: T1 (Growth Stage 52: one
quarter ear emergence) or T2 (Growth Stage 65-69: one week after full ear emergence,
ie at time of anthesis).

| | | | | | | Thousand | Thousand |
|---|---|---|---|---|---|---|---|
| | | Grain | Grain | Grain | Grain | Grain | Grain |
| | | Yield | Yield | Yield | Yield | Weight | Weight |
| | | (g per | (%) | (g per | (%) | (g) | (g) |
| | | Pot) T1 | T1 | Pot) T2 | T2 | T1 | T2 |
| Treatment | | Timing | Timing | Timing | Timing | Timing | Timing |
| 1. | Untreated | 30.0 | 100.3 | 30.0 | 100.3 | 48.1 | 47.6 |
| 2. | Untreated | 29.8 | 99.7 | 29.8 | 99.7 | 47.8 | 47.7 |
| 3. | AN | 29.8 | 99.7 | 29.5 | 98.7 | | |
| 4. | AC | 29.3 | 98.0 | 31.0 | 103.7 | | |
| 5. | AN + AC | 29.3 | 98.0 | 29.8 | 99.7 | 47.7 | 47.8 |
| 6. | AN + AC + | 30.3 | 101.3 | 30.2 | 101.0 | | |
| | Terpene | | | | | | |
| 7. | ADD | 30.0 | 100.3 | 30.2 | 101.0 | | |
| 8. | AN + ADD | 29.9 | 100.0 | 30.2 | 101.0 | | |
| 9. | AC + ADD | 29.8 | 99.7 | 30.1 | 100.7 | | |
| 10 | AN + AC + ADD | 31.6 | 105.3 | 31.8 | 106.0 | 48.9 | 49.0 |
| 11 | AN + AC + | 31.9 | 106.7 | 32.0 | 106.7 | 49.1 | 49.2 |
| | ADD + Terpene | | | | | | |
| 12 | Thiosulphate | 32.4 | 108.4 | 33.4 | 111.7 | 50.4 | 50.7 |
| 13 | Thiosulphate + | 32.5 | 108.7 | 33.3 | 111.4 | 50.9 | 51.0 |
| | AN + AC | | | | | | |
| 14 | Thiosulphate + | 34.1 | 114.0 | 34.4 | 115.0 | 51.7 | 52.2 |
| | AN + AC + ADD | | | | | | |
| 15 | Thiosulphate + | 34.3 | 114.7 | 34.6 | 115.7 | 52.1 | 52.3 |
| | AN + AC + ADD + | | | | | | |
| | Terpene | | | | | | |
| 16 | Cytokinin | 33.0 | 110.4 | 32.9 | 110.0 | 50.5 | 50.4 |
| 17 | Cytokinin + AN | 32.8 | 109.9 | 33.0 | 110.4 | | |
| 18 | Cytokinin + AC | 33.0 | 110.7 | 32.0 | 107.0 | | |
| 19 | Cytokinin + | 33.5 | 112.0 | 33.3 | 111.4 | 51.1 | 51.3 |
| | AN + AC | | | | | | |
| 20 | Cytokinin + | 33.9 | 113.4 | 34.0 | 113.7 | 53.2 | 53.3 |
| | AN + AC + ADD | | | | | | |
| 21 | Cytokinin + | 34.2 | 114.3 | 34.1 | 114.0 | 53.3 | 53.2 |
| | AN + AC + ADD + | | | | | | |
| | Terpene | | | | | | |
| 22 | Cytokinin + ADD | 33.0 | 110.4 | 32.3 | 108.0 | | |
| 23 | Cytokinin + | 31.8 | 106.4 | 31.8 | 106.4 | | |
| | ADD + Terpene | | | | | | |
| 24 | Cytokinin + | 32.9 | 110.0 | 32.8 | 109.7 | | |
| | Terpene | | | | | | |
| 25 | Cytokinin + | 33.1 | 110.7 | 33.2 | 111.0 | | |
| | Thiosulphate | | | | | | |
| 26 | Cytokinin + | 33.0 | 110.4 | 33.1 | 110.7 | | |
| | Thiosulphate + ADD | | | | | | |
| 27 | Cytokinin + | 33.5 | 112.0 | 33.6 | 112.4 | 52.2 | 52.4 |
| | Thiosulphate + | | | | | | |
| | AN + AC | | | | | | |
| 28 | Cytokinin + | 34.7 | 116.1 | 34.8 | 116.4 | 54.3 | 54.3 |
| | Thiosulphate + | | | | | | |
| | AN + AC + ADD | | | | | | |
| 29 | Cytokinin + | 33.2 | 111.0 | 33.1 | 110.7 | | |
| | Thiosulphate + | | | | | | |
| | Terpene | | | | | | |
| 30 | Cytokinin + | 34.6 | 115.7 | 34.9 | 116.7 | 54.0 | 54.2 |
| | Thiosulphate + | | | | | | |
| | AN + AC + ADD + | | | | | | |
| | Terpene | | | | | | |
| 31 | Terpene + ADD | 29.5 | 98.7 | 29.8 | 99.7 | | |
| 32 | Terpene | 30.2 | 101.0 | 30.3 | 101.3 | | |

TABLE 3
Phaseolus vulgaris (NAVY BEAN) - cv Primel - SEED YIELD AND
THOUSAND SEED WEIGHT BENEFITS FROM THE FOLLOWING APPLICATION
TIMINGS: T1 (Growth Stage R1: first flowering) or T2 (Growth Stage R3).

| | | Seed | | Seed | | Indiv | Indiv |
|---|---|---|---|---|---|---|---|
| | | Yield | Seed | Yield | Seed | Seed | Seed |
| | | (g per | Yield | (g per | Yield | Weight | Weight |
| | | Pot) | (%) | Pot) | (%) | (mg) | (mg) |
| | | T1 | T1 | T2 | T2 | T1 | T2 |
| Treatment | | Timing | Timing | Timing | Timing | Timing | Timing |
| 1. | Untreated | 55.3 | 101.7 | 55.3 | 101.7 | 259 | 256 |
| 2 | Untreated | 53.5 | 98.3 | 53.5 | 98.3 | 261 | 259 |
| 3 | AN (Anthranilic Acid) | 55.5 | 102.0 | 53.3 | 98.0 | | |
| 4 | AC (Acetaminophen) | 53.3 | 98.0 | 54.3 | 99.8 | | |
| 5. | AN + AC | 55.2 | 101.5 | 55.3 | 101.7 | | |
| 6. | AN + AC + Terpene | 55.6 | 102.2 | 55.3 | 101.7 | | |
| 7. | ADD | 55.7 | 102.4 | 55.6 | 102.2 | | |
| 8. | AN + ADD | 54.8 | 100.7 | 54.9 | 100.9 | | |
| 9. | AC + ADD | 54.2 | 99.6 | 54.4 | 100.0 | | |
| 10 | AN + AC + ADD | 57.8 | 106.3 | 57.9 | 106.4 | 268 | 265 |
| 11 | AN + AC + | 57.5 | 105.7 | 58.0 | 106.6 | 269 | 268 |
| | ADD + Terpene | | | | | | |
| 12 | Thiosulphate | 59.1 | 108.6 | 59.8 | 109.9 | 276 | 275 |
| 13 | Thiosulphate + AN + AC | 60.3 | 110.8 | 60.2 | 110.7 | 281 | 282 |
| 14 | Thiosulphate + | 62.9 | 115.6 | 63.3 | 116.4 | 285 | 283 |
| | AN + AC + ADD | | | | | | |
| 15 | Thiosulphate + | 63.0 | 115.8 | 63.4 | 116.5 | 289 | 290 |
| | AN + AC + | | | | | | |
| | ADD + Terpene | | | | | | |
| 16 | Cytokinin | 58.2 | 107.0 | 58.4 | 107.4 | 278 | 277 |
| 17 | Cytokinin + | 58.1 | 106.8 | 58.4 | 107.4 | | |
| | AN | | | | | | |
| 18 | Cytokinin + | 58.3 | 107.2 | 58.3 | 107.2 | | |
| | AC | | | | | | |
| 19 | Cytokinin + | 59.8 | 109.9 | 59.6 | 109.6 | 283 | 284 |
| | AN + AC | | | | | | |
| 20 | Cytokinin + | 63.5 | 116.7 | 63.0 | 115.8 | 290 | 289 |
| | AN + AC + ADD | | | | | | |
| 21 | Cytokinin + | 62.5 | 114.9 | 62.3 | 114.5 | 292 | 293 |
| | AN + AC + | | | | | | |
| | ADD + Terpene | | | | | | |
| 22 | Cytokinin + | 58.3 | 107.2 | 58.2 | 107.0 | | |
| | ADD | | | | | | |
| 23 | Cytokinin + | 58.0 | 106.6 | 58.1 | 106.8 | | |
| | ADD + Terpene | | | | | | |
| 24 | Cytokinin + | 58.2 | 107.0 | 58.4 | 107.4 | | |
| | Terpene | | | | | | |
| 25 | Cytokinin + | 60.2 | 110.7 | 60.4 | 111.0 | | |
| | Thiosulphate | | | | | | |
| 26 | Cytokinin + | 60.4 | 111.0 | 60.6 | 111.3 | | |
| | Thiosulphate + ADD | | | | | | |
| 27 | Cytokinin + | 61.7 | 113.4 | 62.3 | 114.5 | 288 | 290 |
| | Thiosulphate + | | | | | | |
| | AN + AC | | | | | | |
| 28 | Cytokinin + | 64.8 | 119.1 | 65.5 | 120.4 | 297 | 299 |
| | Thiosulphate + | | | | | | |
| | AN + AC + ADD | | | | | | |
| 29 | Cytokinin + | 60.0 | 110.3 | 59.9 | 110.1 | | |
| | Thiosulphate + Terpene | | | | | | |
| 30 | Cytokinin + | 66.0 | 121.3 | 67.0 | 123.2 | 297 | 296 |
| | Thiosulphate + | | | | | | |
| | AN + AC + | | | | | | |
| | ADD + Terpene | | | | | | |
| 31 | Terpene + | 54.8 | 100.7 | 54.9 | 100.9 | | |
| | ADD | | | | | | |
| 32 | Terpene | 54.9 | 100.9 | 55.0 | 100.4 | | |

TABLE 4
Glycine max (SOYBEAN) - SEED YIELD AND THOUSAND SEED
WEIGHT BENEFITS FROM THE FOLLOWING APPLICATION TIMINGS: T1
(Growth Stage R1: first flowering) or T2 (Growth Stage R3).

| | | Seed | | Seed | | Thousand | Thousand |
|---|---|---|---|---|---|---|---|
| | | Yield | Seed | Yield | Seed | Seed | Seed |
| | | (g per | Yield | (g per | Yield | Weight | Weight |
| | | Pot) | (%) | Pot) | (%) | (g) | (g) |
| | | T1 | T1 | T2 | T2 | T1 | T2 |
| Treatment | | Timing | Timing | Timing | Timing | Timing | Timing |
| 1. | Untreated | 33.3 | 101.2 | 33.3 | 101.2 | 150 | 153 |
| 2 | Untreated | 32.5 | 98.8 | 32.5 | 98.8 | 154 | 152 |
| 3 | AN (Anthranilic Acid) | 32.8 | 99.7 | 33.3 | 101.2 | | |
| 4 | AC (Acetaminophen) | 33.5 | 101.8 | 33.5 | 101.8 | | |
| 5. | AN + AC | 33.8 | 102.7 | 33.5 | 101.8 | 154 | 153 |
| 6. | AN + AC + | 33.5 | 101.8 | 33.6 | 102.1 | | |
| | Terpene | | | | | | |
| 7. | ADD | 32.8 | 99.7 | 33.0 | 100.3 | | |
| 8. | AN + ADD | 33.1 | 100.6 | 33.2 | 100.9 | | |
| 9. | AC + ADD | 32.9 | 100.0 | 33.0 | 100.3 | | |
| 10 | AN + AC + | 34.7 | 105.5 | 34.8 | 105.8 | 156 | 155 |
| | ADD | | | | | | |
| 11 | AN + AC + | 35.1 | 106.7 | 35.0 | 106.4 | 158 | 157 |
| | ADD + Terpene | | | | | | |
| 12 | Thiosulphate | 35.8 | 108.8 | 36.3 | 110.3 | 160 | 159 |
| 13 | Thiosulphate + | 36.6 | 111.2 | 37.5 | 114.0 | 163 | 162 |
| | AN + AC | | | | | | |
| 14 | Thiosulphate + | 40.0 | 121.6 | 41.3 | 125.5 | 166 | 165 |
| | AN + AC + | | | | | | |
| | ADD | | | | | | |
| 15 | Thiosulphate + | 40.2 | 122.2 | 41.1 | 124.9 | 168 | 169 |
| | AN + AC + | | | | | | |
| | ADD + Terpene | | | | | | |
| 16 | Cytokinin | 39.3 | 119.5 | 38.8 | 117.9 | 164 | 165 |
| 17 | Cytokinin + | 40.2 | 122.2 | 40.3 | 122.5 | | |
| | AN | | | | | | |
| 18 | Cytokinin + | 39.7 | 120.7 | 38.9 | 118.2 | | |
| | AC | | | | | | |
| 19 | Cytokinin + | 41.0 | 124.6 | 40.9 | 124.3 | 169 | 173 |
| | AN + AC | | | | | | |
| 20 | Cytokinin + | 44.0 | 133.7 | 43.3 | 131.6 | 175 | 177 |
| | AN + AC + | | | | | | |
| | ADD | | | | | | |
| 21 | Cytokinin + | 43.3 | 131.6 | 43.3 | 131.6 | 178 | 177 |
| | AN + AC + | | | | | | |
| | ADD + Terpene | | | | | | |
| 22 | Cytokinin + | 39.3 | 119.5 | 39.0 | 118.5 | | |
| | ADD | | | | | | |
| 23 | Cytokinin + | 39.8 | 121.0 | 39.5 | 120.0 | | |
| | ADD + Terpene | | | | | | |
| 24 | Cytokinin + | 40.1 | 121.9 | 40.2 | 122.2 | | |
| | Terpene | | | | | | |
| 25 | Cytokinin + | 41.0 | 124.6 | 41.1 | 124.9 | | |
| | Thiosulphate | | | | | | |
| 26 | Cytokinin + | 40.9 | 124.3 | 41.0 | 124.6 | | |
| | Thiosulphate + | | | | | | |
| | ADD | | | | | | |
| 27 | Cytokinin + | 42.0 | 127.7 | 41.6 | 126.4 | 175 | 174 |
| | Thiosulphate + | | | | | | |
| | AN + AC | | | | | | |
| 28 | Cytokinin + | 45.1 | 137.1 | 45.7 | 138.9 | 179 | 178 |
| | Thiosulphate + | | | | | | |
| | AN + AC + | | | | | | |
| | ADD | | | | | | |
| 29 | Cytokinin + | 41.1 | 124.9 | 40.8 | 124.0 | | |
| | Thiosulphate + | | | | | | |
| | Terpene | | | | | | |
| 30 | Cytokinin + | 45.8 | 139.2 | 45.5 | 138.3 | 178 | 179 |
| | Thiosulphate + | | | | | | |
| | AN + AC + | | | | | | |
| | ADD + Terpene | | | | | | |
| 31 | Terpene + | 33.6 | 102.1 | 32.9 | 100.0 | | |
| | ADD | | | | | | |
| 32 | Terpene | 33.1 | 100.6 | 33.0 | 100.3 | | |

### Grain Quality Improvement

Trials information: grown in pots in standard multi-purpose compost of pH 6.5, at 6/7 seeds per 9 cm pot (winter wheat), or 5/6 seeds per 9 cm pot (winter barley). Sprayed at the start of the anthesis growth stage (=shortly after ear emergence: GS60)

| | Specific Weight | % Screenings | % Screenings |
|---|---|---|---|
| | (kg/hl) | (2.2 mm) | (2.5 mm) |
| A. Winter Wheat | | | |
| (Mean of 3 Varieties) | | | |
| 1. Untreated | 71.3 | 6.9 | 11.3 |
| 2. AN + AC | 72.1 | 5.6 | 10.5 |
| 3. AN + AC + ADD | 74.1 | 4.1 | 8.5 |
| 4. AN + AC + thiosulphate | 76.5 | 2.6 | 5.2 |
| 5. AN + AC + ADD + | 77.0 | 2.5 | 4.0 |
| thiosulphate | | | |
| 6. Thiosulphate | 74.0 | 4.5 | 8.0 |
| 7. AN + AC + cytokinin | 75.2 | 2.6 | 4.1 |
| 8. AN + AC + ADD + | 77.1 | 2.5 | 6.7. |
| cytokinin | | | |
| 9. Cytokinin | 74.5 | 4.3 | 8.3 |
| B. Winter Barley | | | |
| (Mean of 3 Varieties) | | | |
| 1. Untreated | 65.1 | 5.8 | 12.0 |
| 2. AN + AC | 66.0 | 6.0 | 12.5 |
| 3. AN + AC + ADD | 69.8 | 4.5 | 8.4 |
| 4. AN + AC + thiosulphate | 72.9 | 2.5 | 5.2 |
| 5. AN + AC + ADD + | 73.0 | 2.0 | 5.2 |
| thiosulphate. | | | |
| 6. Thiosulphate | 68.3 | 4.8 | 7.3 |
| 7. AN + AC + cytokinin | 71.4 | 4.9 | 7.7 |
| 8. AN + AC + ADD + | 73.6 | 1.9 | 4.0 |
| cytokinin | | | |
| 9. Cytokinin | 71.9 | 5.2 | 7.8 |

Application of the compositions of the present invention sprayed at start of the anthesis growth stage (=shortly after ear emergence: GS60) in winter wheat and winter barley provided increased grain quality, over and above application of AN+AC alone, or untreated. There is a synergistic benefit to specific weight attributes for both winter wheat and winter barley.

All publications mentioned in the above specification are herein incorporated by reference. Various modifications and variations of the described methods and systems of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes of carrying out the invention which are obvious to those skilled in the field are intended to be within the scope of the following claims.

1-24. (canceled)

25. A composition suitable for improving seed quality in a plant comprising:
(i) a compound selected from an auxin, an auxin precursor, an auxin metabolite or a derivative of said auxin, auxin precursor or auxin metabolite;
(ii) acetaminophen or a derivative thereof; preferably acetaminophen;
and further comprising at least one compound selected from (iii) to (v) wherein:
(iii) is a cytokinin,
(iv) is an agrochemically acceptable additive comprising at least one compound selected from a) glucose, hydrolysed starch, sucrose, fructose, glycerol, glyceraldehydes, erythrose, ribulose, xylulose or arabinose, monosaccharides including aldoses such as D-Ribose, D-Xylose, L-Arabinose, D-Glucose, D-Mannose and D-Galactose; ketoses such as D-Ribulose and D-Fructose; deoxyaldoses such as 2-Deoxy-D-ribose, L-Fuccose; acetylated amino sugars such as N-Acteyl-D-glucosamine and N-Acetyl-D-galactosamine; acidic monosaccharides such as D-Glucuronic acid, L-Iduronic acid and N-Acetylneuraminic acid, Sugar alcohols such as D-Sorbitol and D-Mannitol, disaccharides including maltose, lactose and sucrose, or an ester or glycoside or metabolic equivalent of such a carbohydrate; b) an organic acid of the Krebs tricarboxylic acid cycle or a metabolic precursor thereof; c) a vitamin or coenzyme, or a precursor thereof; d) a purine or pyrimidine nucleoside, nucleotide or metabolic precursor thereof; e) a naturally occurring fat or oil; or f) an amino acid, and
(v) is thiosulphate.

26. The composition of claim 25 comprising components (i), (ii) and (iii).

27. The composition of claim 25 comprising components (i), (ii) and (iv).

28. The composition of claim 25 comprising components (i), (ii), (iii) and (iv).

29. The composition of claim 25 comprising components (i), (ii) and (v).

30. The composition according to claim 25 wherein the agrochemically acceptable additive (iv) comprises at least one compound selected from c) a vitamin or coenzyme, or a precursor thereof; d) a purine or pyrimidine nucleoside, nucleotide or metabolic precursor thereof; or f) an amino acid.

31. The composition according to claim 25 wherein the composition further comprises an adjuvant.

32. The composition according to claim 25 wherein the auxin is an indolic auxin or a phenolic auxin.

33. The composition according to claim 25 wherein the derivative is an acid, a conjugate, a salt, an ester, or an amide of the auxin, or an alkylated or halogenated auxin.

34. The composition according to claim 33 wherein the auxin is conjugated to a sugar, an alcohol, an amino acid or a protein.

35. The composition according to claim 25 wherein the precursor is chorismate, anthranilic acid, phosphoribosyl anthraniliate, 1-(O-carboxyphenulamino)-1-deoxyribulose-5-phosphate, indole-3-glycerol-phosphate, indole, indole-3-acetic acid, tryptophan, tryptamine, N-hydroxy tryptamine, indole-3-acetaldoxime, 1-aci-nitro-2-indolylethane, indolic glucosinate, indole-3-acetonitrile (IAN), indole-3-acetaldehyde, indole-3-lactic acid, indole-3-pyruvic acid, or indole-3-ethanol.

36. The composition according to claim 35 wherein the precursor is anthranilic acid.

37. The composition according to claim 25 wherein the auxin is a natural or synthetic auxin.

38. The composition according to claim 37 wherein the auxin is a natural auxin selected from indole-3-acetic acid (IAA), 4-chloro-indole-3-acetic acid (4-Cl-IAA), phenylacetic acid (PAA), indole-3-butyric acid (IBA), indole-3-acetyl-1-O-D-glucose (IAAglc); or a synthetic auxin selected from 1-naphthaleneacetic acid (NAA), 2,4-dichlorophenoxyacetic acid (2,4-D), 2-methoxy-3,6-dichlorobenzoic acid (dicamba), 4-amino-3,5,6-trichloropicolinic acid (tordon), 2,4,5-trichlorophenoxyacetic acid (2,4,5-T), 2,3,6-trichlorobenzoic acid or N,N-dimethylethylthiocarbamate.

39. The composition according to claim 37 wherein the conjugate of the natural auxin is IAA-Inositol, IAA-Inositol-arabinose, IAP1, an IAA-peptide, an IAA glycoprotein, an IAA-glucan, IAA-aspartate, IAA-glucose, IAA-1-O-glucose, IAA-myo-Inositol, IAA-4-O-glucose, IAA-6-O-glucose, IAA-Inositol-galactose, an IAA amide conjugate, or an IAA-amino acid conjugate.

40. The composition according to claim 25 wherein the metabolite is indole-3-lactic acid or indole-3-ethanol.

41. The composition of claim 25 for use to improve seed quality.

42. A method for improving seed quality comprising applying the composition of claim 25 to a plant, its seeds or its environs.

43. The method of claim 42 wherein the plant is a crop.

44. A method of preparing the composition of claim 25 comprising admixing components (i) and (ii) with at least one of components (iii) to (v).
